(19) United States
(12) Patent Application Publication
(10) Pub. No.: US 2017/0233109 A1
(43) Pub. Date: Aug. 17, 2017

(54) Reusable Staging System For Launch Vehicles

(71) Applicant: Arthur Mckee Dula, Houston, TX (US)

(72) Inventor: Arthur Mckee Dula, Houston, TX (US)

(21) Appl. No.: 15/256,457

(22) Filed: Sep. 2, 2016

Related U.S. Application Data
(63) Continuation of application No. 14/195,311, filed on Mar. 3, 2014, now abandoned.
(60) Provisional application No. 61/771,854, filed on Mar. 2, 2013.

(51) Int. Cl. B64G 1/00; B64G 1/24; B64G 1/40

(52) U.S. Cl. CPC B64G 1/002; B64G 1/40; B64G 1/24

(57) ABSTRACT

A reusable staging system comprising: a processor-based device configured to monitor one or more rocket stages of a launch vehicle having a payload, wherein the processor-based device has at least one interface communicating with the one or more rocket stages of the launch vehicle; and a memory device for storing data and executing software routines, and wherein the reusable staging system is disposed within the payload of the launch vehicle, and wherein the reusable staging system is configured to actively monitor flight-related data to detect one or more detach requirements; and further configured to release the one or more rocket stages when the one or more detach requirements is met.

### BACKGROUND OF THE INVENTION

The invention relates generally to expendable launch vehicles, and more particularly to staging systems used in expendable launch vehicles.

Multiple stage launch vehicles are generally single-use launch vehicles comprising several rocket stages. Multiple stage launch vehicles jettison one or more stages as they expend their fuel. Expendable launch vehicles are effectively multiple rockets stacked on top of each other in order to reduce the total amount of mass that needs to be accelerated to a final speed and/or height, generally to achieve orbit. While it is possible in principle to use a single stage launch vehicle, it is generally more efficient to use multiple stage launch vehicles when the detached components are not intended to be recovered intact.

Each stage generally comprises of one or more motors, fuel and oxidizer tanks for a liquid fuel rocket or a casing for a solid fuel rocket. The first stage is at the bottom and is usually the largest. The second stage follows above it and is usually the next largest, etc. This is known as “linear staging.” When the first stage's motor fires, the entire spacecraft is propelled upwards. When the first stage runs out of fuel, it is detached from the rest of the spacecraft and falls away. This leaves a smaller spacecraft, with the second stage on the bottom, which then fires. This process is repeated until the final stage's motor bums out.

Once a stage's fuel is expended, the space and structure which contained the fuel and the motors are useless. By detaching and discarding the stages which are no longer useful, the rocket reduces its overall weight. When a stage is discarded, the rest of the spacecraft is still traveling near to the speed that the whole assembly reached at the burn-out time of said stage. Accordingly, the thrust of subsequent stages is able to provide more acceleration than if the earlier stages or boosters were still attached. This means that the rocket needs less total fuel to reach a given velocity and/or altitude.

Another advantage for using multiple stages is that each stage can use a different type of rocket motor tuned for the conditions in which it will operate. For example, the lower stage booster can use a motor suited for use at atmospheric pressure, while the upper stages can use motors suited for near vacuum conditions. Lower stages tend to require more structure than the upper stages, as they need to bear their own weight in addition to that of the stages above them. Optimizing the structure of each stage decreases the weight of the total vehicle.

In between each stage, are smaller sections called interstages. Interstages generally serve as a buffer between stages to give room to house the engines. The interstage is usually detached with the stage below it so that the stage above fires. Interstages designed precisely to give just enough room for the interstage to release without touching the engines above.

Usually, between the payload and the final stage is an instrument unit. The instrument unit comprises electronic systems that control the operations of the rocket from just before liftoff to when the final stage is detached, including determining when to detach each stage, and determining when to fire the next stage. The instrument unit also includes guidance and telemetry systems for the rocket. By measuring acceleration and altitude, it can calculate the position and velocity of the rocket and correct for any deviations. Essentially, the instrument unit serves as the staging system. However, like the interstages, the instrument unit is detached and discarded after the final stage burns out. This costly component must be replaced for each launch, and accordingly, there is a need for a system and method for reusing the instrument unit as a staging system in subsequent launches.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION

Embodiments provide a staging system instrument unit designed to be reusable for successive launches. A staging system according to certain embodiments are designed to replace traditional single-use instrument units with little or no change to existing components of the launch vehicle. Certain embodiments comprise a staging system integrated with a main control system of a payload. A payload can be a space capsule carrying passengers.

The staging system typically monitors the launch vehicle from just before take off to until the last rocket stage is detached and discarded. This is accomplished by an interface in the staging system communicating with each rocket stage. Through the interface, a staging system can monitor various parameters and determine appropriate times to detach each stage. For example, when the bottom-most stage has expended all of its fuel, or the launch vehicle has reached a pre-determined altitude and/or velocity a staging system will detach and discard the bottom-most stage from the launch vehicle. Releasing the bottom-most stage may be accomplished by various methods, such as detonating small explosive charges. A staging system may further comprise systems for guidance and telemetry. By monitoring acceleration and altitude, the staging system can correct for deviations from the launch plan.

The staging system's interface is designed such that when the final stage is detached, the connection between the staging system and the last stage is severed, and the staging system ceases to monitor any stage. The staging system remains intact in the payload as it returns to the planetary surface. Afterwards, the staging system's interface may be connected to a subsequent set of rocket stages of a launch vehicle in a subsequent launch. This reusable feature is desirable in that it saves the cost of having to provide a new staging system for each launch.

### DRAWINGS

These and other features, aspects, and advantages of the embodiments will become better understood when the following detailed description is read with reference to the accompanying drawings in which like characters represent like parts throughout the drawings, wherein:

FIG. 1 illustrates a typical multiple stage expendable launch vehicle;

FIG. 2 is a diagram showing the control system of a manned space capsule payload, in accordance with an embodiment;

FIG. 3 is a diagram showing how a staging system interfaces with a first set of rocket stages in accordance with an embodiment;

FIG. 4 is a diagram showing how a staging system interfaces with a subsequent set of rocket stages following release of the first set of rocket stages in accordance with an embodiment;

FIG. 5 diagram showing a flow chart of an exemplary technique for re-using a staging system in accordance with an embodiment; and

FIG. 6 shows a schematic of a staging system in accordance with an embodiment.

### DETAILED DESCRIPTION

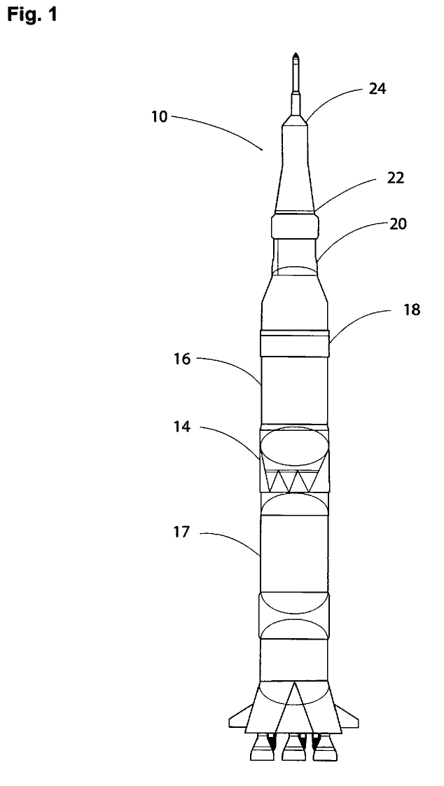

Turning now to the drawings, and referring first to FIG. 1, a typical multiple stage expendable launch vehicle 10 is shown having an expendable staging system. The instrument unit comprising the staging system 22 monitors the launch vehicle 10 from just before take off until the last stage is detached.

During a typical launch, the first stage 12 undergoes ignition and begins to burn fuel. As fuel is burned, the launch vehicle 10 is propelled by exhaust gases being ejected at high speed. Rocket stages can use either liquid or solid fuels or a combination of both as in a hybrid rocket. The type of fuel, as well as the motors for the rockets, may depend on atmospheric conditions in which a stage is intended to operate.

When the staging system 22 determines that the first stage 12 has expended most or all of its fuel, the staging system 22 sends a signal to detach the first stage 12. One method of detaching the empty stage is to detonate small explosive charges located at points where the stage is connected to the interstage 14 above it. Once the stage has separated from the launch vehicle body, it falls away back into the atmosphere. Shortly thereafter, the bottom-most interstage 14 is also detached from the launch vehicle body. The interstages are designed to be buffer zones for the engines of the subsequent stage.

Once the bottom-most interstage 14 has cleared the engines of the second stage 16, the next set of engines begins to fire, accelerating a lighter launch vehicle. Once the fuel for the second stage 16 is expended, the staging system 22 causes the second stage 16 to detach from the launch vehicle body. Shortly thereafter, the bottom-most remaining interstage 18 is released. The staging system 22 causes the third stage engines fire. In this particular illustration, the third stage 20 is also the last stage. Once the third stage 20 fuel is expended, the final stage is detached and discarded from the rocket. Having no further need to monitor rocket stages, the instrument unit 22 is subsequently detached and discarded, leaving only the payload 24. At this point, the payload 24 will have reached its target altitude, or will have gained enough velocity to further propel it to that altitude. Target altitude is usually one sufficient to achieve lower earth orbit. The discarded instrument unit 22 is non-recoverable, and is a sunk cost of the launch. Once the final stage 20 has been detached from the launch vehicle, only the payload structure 24 is left in flight. In the example illustrated herein, the payload 24 is a manned reentry capsule. However, the payload 24 may also be an unmanned cargo vehicle or any other spacecraft.

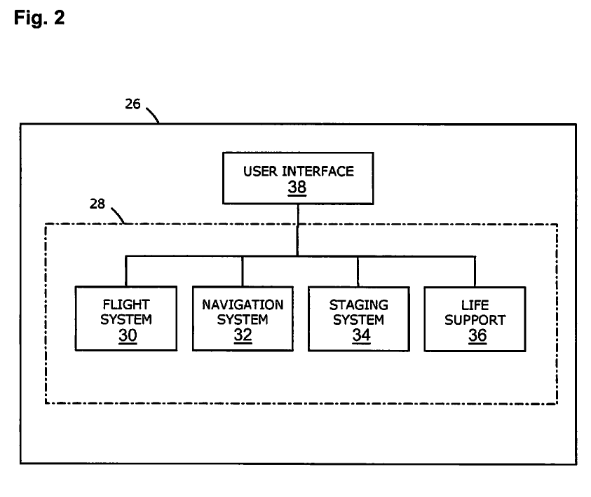

FIG. 2 shows a control system 26 for a returnable space capsule in accordance with an embodiment. System block 28 illustrates various systems for operating the capsule comprising: a flight system 30, a navigation system 32, a staging system 34 and life support system 36. For purposes of illustration, only the named systems are shown, as these are generally regarded as more vital components. It should be appreciated that a system block 28 in accordance with certain embodiments could comprise various other systems and sub-systems in accordance with an embodiment. For example, the control system 26 could comprise additional systems.

A user interface 38 provides means for communication with and control of systems, relaying various input and output signals to and from the systems 28. For example, a crew member may provide reaction control system (RCS) input to the flight system 30 via user interface 38. Similarly, a crew member may control the staging system 34 and the detachment timing of the stages via the user interface 38, although stage detachment actions are usually monitored and configured to occur automatically at one or more carefully preset conditions, such as altitude and fuel level.

Manual control of the staging system 34 risks the premature detachment of a stage. Such an occurrence may leave the launch vehicle unable to reach its intended altitude, and risks having a detached rocket stage firing its motor while flying in close proximity to the spacecraft. Manual control may be a desirable option in the event that a malfunction with the automated system causes a rocket stage or interstage to fail to detach properly.

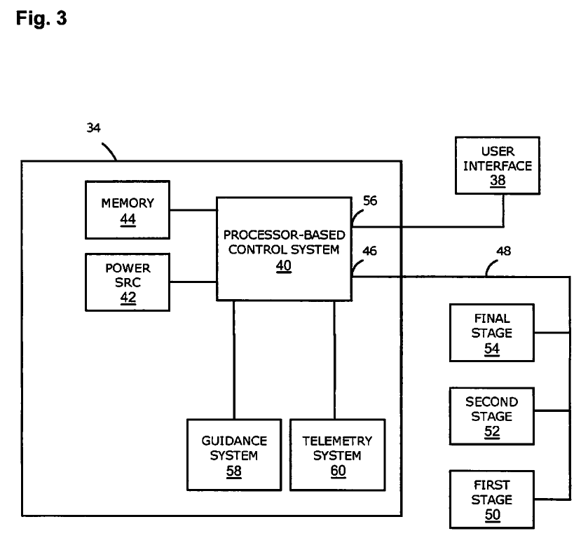

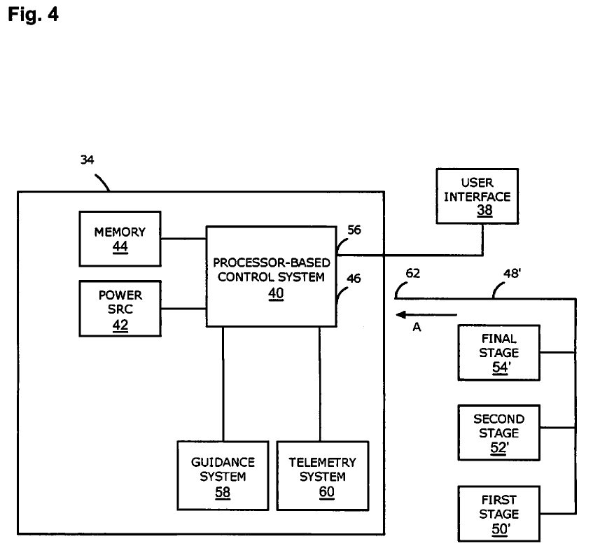

Referring now to FIGS. 3 and 4, a detailed view of a staging system 34 in accordance with an embodiment is illustrated. The staging system 34 comprises a processor-based control system 40, such as a computer having one or more microprocessors. The processor-based control system 40 is powered by a power source 42, which may be standalone, or shared from the main power source for the control system 26. The processor-based control system 40 may interface with a memory device 44, such as non-volatile memory (ROM) for storing software programs and variable sets for stage monitoring. Although not shown in FIG. 3, it should be understood that the processor-based control system may further comprise hard disk drives for storing data and programs, volatile memory (RAM), and other hardware components.

The processor based control system is connected to a user interface 38, as shown in FIG. 3. Data connection point 56 represents an interface connecting the processor-based control system 40 to the user interface 38, as shown in FIG. 4. Manual control of the staging system 34 may be a desirable back-up feature in the event that the automated system malfunctions. The processor-based control system 40 can communicate with a guidance system 58 and a telemetry system 60 to aid the launch vehicle in correcting for any deviation from the flight plan.

A data bus 48 connects the staging system 34 to the first stage 50, second stage 52, and final stage 54. Data connection point 46 connects the processor-based control system 40 to the data bus 48. Data bus 48 carries information between the processor-based control system 40 and the rocket stages. For example, the first stage 50 may send a signal to processor-based control system 40 along the data bus 48 indicating that its propellant tanks are empty. The processor-based control system 40 can determine if a target altitude has been reached by communicating with the guidance 58 and telemetry 60 systems. If the processor-based control system 40 determines that the first stage 50 should detach, it sends a signal along data bus 48, causing the first stage 50 to detach from the launch vehicle 10. The staging system 34 operates in a similar fashion to determine when second stage 52 and final stage 54 should detach. It should be understood that although the data bus 48 is depicted as a single line for purposes of illustration, the data bus 48 may be a plurality of data lines having one or more lines corresponding to each rocket stage, and that the data connection point 46 may be configured to receive data from each of these lines.

When the final stage 54 is detached, the data bus 48 disconnects from the data connection point 46. At this point, the staging system 34 has no further function until a subsequent launch. Capsule reentry operations are governed by flight, navigation, and reaction control systems. On a subsequent launch, a new set of rocket stages (first stage 50′, second stage 52′ and final stage 54′) can be interfaced with the staging system 34 by connecting the end 62 of a new data bus line 48′ to the processor-based control system 40 at data connection point 46. For purposes of illustration, arrow A represents the direction of the connection of the new data bus 48′ to the staging system 34. During launch, the operations governing the launch and detachment of the previous set of rocket stages are substantially identical. The same staging system 34 can be reused because it has not been detached and discarded at the last phase of the previous launch.

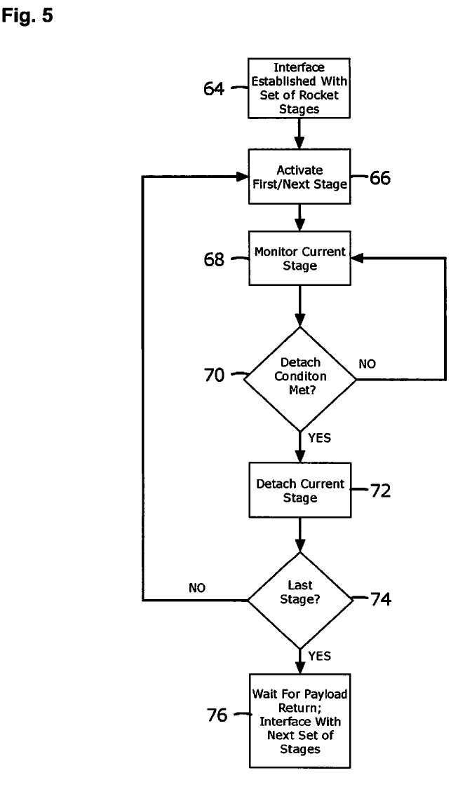

FIG. 5 shows a method for re-using a staging system as illustrated in a flowchart, in accordance with an embodiment. A data bus 48 is initially interfaced with the staging system 34 by a data connection 46 on the processor-based control system 40, as depicted in block 64. At the start of a launch, the first stage ignites 66 and begins burning fuel, propelling the launch vehicle upwards. For purposes of illustration, a stage that is currently bottom-most is referred to as an active stage.

During the launch, the staging system 34 monitors the active stage for the presence of a release condition, as depicted in block 68. A release condition may be a combination of conditions, such as the active stage having expended all of its fuel, and the launch vehicle having reached a certain altitude. As depicted in block 70, if a release condition is not present, the staging system 34 continues to monitor the active stage. If a release condition has been met, the staging system 34 initiates a detachment procedure for the active stage, as depicted in block 72. As discussed previously, the detachment procedure may include sending a detach signal along a data bus 48 to the current stage, thereby triggering a release mechanism, such as detonation of small explosive charges or a mechanical mechanism, thereby detaching the current stage from the launch vehicle. The release mechanism may also trigger the detachment of the interstage between the active stage and the next stage.

After the active stage is detached, the staging system 34 determines if the detached stage is the last stage, as depicted at block 74. If the detached stage is not the last stage, the staging system 34 sends a signal on data bus 48 to activate the next stage, and the process repeats until the final stage is activated. If the detached stage is the last stage, the connection between the staging system 34 and the stages via data bus 48 may be disconnected. In one embodiment, the data bus 48 may be symbolically disconnected in the sense that it is no longer interfacing with any stages, although it may remain physically connected to the staging system 34. In other embodiments, the data bus 48 may be physically disconnected during the release process of the final rocket stage.

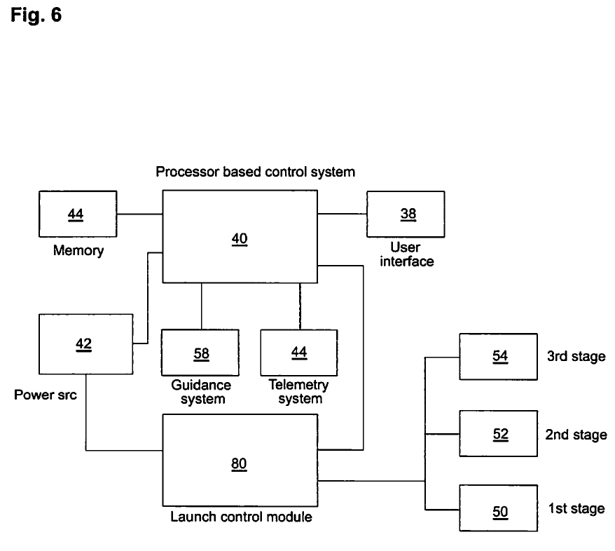

FIG. 6 shows a schematic of a staging system in accordance with an embodiment. The staging system comprises a processor-based control system 40, such as a computer having one or more microprocessors. The processor-based control system 40 may interface with a memory device 44, such as non-volatile memory (ROM) for storing software programs and variable sets for stage monitoring. The processor-based control system 40 is powered by a power source 42, which may be standalone or shared from the main power source. The propulsion control module 80 will also be powered by a power source 42, possibly the same power source 42 that powers the processor based control system 40, as shown in FIG. 6. The propulsion control module 80 comprises an interface to the processor based control system 40 and interfaces to the launch vehicle stages 50, 52, 54.

While only certain features of the select embodiments have been illustrated and described herein, many modifications and changes will occur to those skilled in the art. It is, therefore, to be understood that the appended claims are intended to cover all such modifications and changes as fall within the true spirit of the invention.

### ELEMENT LIST

10 multiple stage expendable launch vehicle (launch vehicle)

12 first stage

14 interstage

16 second stage

18 interstage

20 third stage

22 instrument unit

24 payload

26 main control system

28 system block

30 flight system

32 navigation system

34 staging system

36 life support

38 user interface

40 processor-based control system

42 power source

44 memory device

46 data connection point (staging system)

48 data bus

48′ next data bus

50 first stage

50′ next first stage

52 second stage

52′ next second stage

54 final stage

54′ next final stage

56 data connection point (user interface)

58 guidance system

60 telemetry system

62 data bus interface point

64 establish interface between staging system and first set of rocket stages

66 activate first/next stage

68 monitor current stage

70 determine if release condition met

72 release current stage

74 determine if released stage is last stage

76 interface with next set of rocket stages

A direction of interface connection

1. A reusable staging system comprising:
(a) a processor-based device configured to monitor one or more rocket stages of a launch vehicle having a payload, wherein the processor-based device has at least one interface communicating with the one or more rocket stages of the launch vehicle; and
(b) a memory device for storing data and executing software routines, and wherein the reusable staging system is disposed within the payload of the launch vehicle, and wherein the reusable staging system is configured to actively monitor flight-related data to detect one or more detach requirements; and further configured to release the one or more rocket stages when the one or more detach requirements is met.

2. The staging system as recited in claim 1, further comprising a guidance system communicating with the processor based device.

3. The staging system as recited in claim 1, further comprising a telemetry system communicating with the processor based device.

4. The staging system as recited in claim 1, wherein the processor based device has an interface communicating with a user interface.

5. A method of using a reusable staging system in launch vehicles comprising the acts of:
(a) establishing an interface between the reusable staging system and a first set of one or more stages of a first launch vehicle;
(b) activating a first stage, of the one or more stages, the first stage becoming the current stage;
(c) actively monitoring the current stage until a flight-related detach requirement is met;
(d) releasing the current stage when the flight-related detach requirement is met, the current stage becoming the released stage;
(e) determining if the detached stage is the last stage, and if not, activating the next stage, the next stage becoming the current stage;
(f) repeating steps (c) through (e) until the detached stage is the last stage;
(h) establishing an interface between the reusable staging system and a subsequent set of one or more stages of the a second launch vehicle; and
(i) repeating steps (b) through (f).

6. The method as recited in claim 5, wherein the staging system enters a standby mode when the last stage is detached.

7. The staging system of claim 1, wherein said actively monitored flight-related data comprises altitude data; and wherein said detach requirements comprise whether a minimum altitude has been reached.

8. The method of using a reusable staging system in launch vehicles of claim 5, wherein said flight-related detach requirement comprises reaching a minimum altitude.

9. The staging system of claim 1, wherein said actively monitored flight related data comprises fuel level data; and
wherein said detach requirements comprises whether said rocket stage has consumed an amount of fuel specifically designated for said rocket stage.

10. The method of using a reusable staging system in launch vehicles of claim 5, wherein said flight-related detach requirements comprises consuming an amount of fuel specifically designated for said current stage.
